(19) United States
(12) Patent Application Publication
(10) Pub. No.: US 2007/0184722 A1
(43) Pub. Date: Aug. 9, 2007

(54) Powered modular building block toy

(75) Inventor: Gregory J. Doherty, Cincinnati, OH (US)

Correspondence Address: FROST BROWN TODD, LLC, 2200 PNC CENTER, 201 E. FIFTH STREET, CINCINNATI, OH, 45202, US

(73) Assignee: Dynatech Action, Inc.

(21) Appl. No.: 11/348,845

(22) Filed: Feb. 7, 2006

(51) Int. Cl. H01R 33/00

(52) U.S. Cl. 439/638

(57) ABSTRACT

Embodiments of the present invention provide building blocks with internal electrical circuits (such as LED circuits) that can be mechanically and electrically connected to other blocks with integrated mechanical and electrical connectors. Each block in the present invention may include a plurality of mechanical and electrical connectors that can be joined with the connectors on other blocks. It is desired in these embodiments that the electrical connectors are designed such that they cannot be connected in a manner that results in a short circuit, either due to improper connection of the blocks or due to contact with an external conductor. This is achieved by using card edge type electrical connectors with complementary receptacles. Additionally, the electrical connectors have their contacts arranged such that the proper polarities are maintained regardless of the orientation of the blocks. Certain embodiments of the present invention also provide blocks that can be connected in three dimensions. To achieve this, each block has connectors on a plurality of faces and nearly any block can be coupled with any other block.

### BACKGROUND OF THE INVENTION

1. Field of the Invention

The present invention relates to children's toys, and more particularly to building block toy sets or similar construction systems that include electrical interconnections and that can be assembled together to form larger toys.

2. Description of the Related Art

Several prior art patents describe building block toys designed to convey an electric current when assembled together. Some versions allow a user to inadvertently cause a short circuit by connecting the blocks in an improper manner. Others eliminate this undesirable characteristic but significantly limit the building possibilities in doing so. In particular, most other block type toys do not permit the blocks to be connected in three dimensions. Some other building block toys utilize connection means which leave energized electrical conductors exposed for possible short circuiting by an external conductor.

In European Patent Specification No. 0 852 783 B1 there is disclosed a set of building blocks each comprised of mechanical and multi-conductor electrical connectors and electronic components. The blocks are not capable of being connected in more than two dimensions, with the exception of certain specialized corner blocks that allow a string of blocks to turn a corner. Additionally, unlike the present invention, the mechanical and electrical connectors are capable of being coupled together in only one relative orientation.

Several United States patents cover electrically conductive blocks generally of the “LEGO” type. U.S. Pat. No. 4,556,393 to Bolli, U.S. Pat. No. 4,883,440 to Bolli, U.S. Pat. No. 5,848,503 to Toft et al., and U.S. Pat. No. 6,805,605 to Reining et al. each disclose variations of an electrically conductive toy building block. These blocks are only capable of being connected in one dimension. While these blocks can be connected together in more than one orientation, they all utilize mechanical connectors that contain only single electrical conductors. Unlike the present invention, several of these inventions utilize conductive pins as electrical connectors.

U.S. Pat. No. 4,969,827 to Hahs discloses the use of an edge-type connector, among other types, to connect modular blocks. The disclosed connectors are not capable of being connected in more than one orientation and they utilize the “edge” as the mechanical means of connecting the blocks, unlike the present invention. Additionally, the blocks have exposed, potentially energized conductors that can easily be short-circuited if they come in contact with an external conductor.

U.S. Pat. No. 6,092,937 to Kikuchi discloses a block unit containing multi-conductor electrical connectors that can be connected in three dimensions. The electrical connectors are limited to a specific, concentric circle type. These concentric circle type connectors create a potential short circuit hazard because they leave energized conductors unprotected.

European Patent Specification No. 0 135 633 B1 discloses an electrically connected block-type toy utilizing conically-shaped mechanical connectors and prong-type electrical connectors with contact plates. Besides not being user friendly for children, this invention presents an external short circuit hazard because energized conductors can be left exposed.

### SUMMARY OF THE INVENTION

Embodiments of the present invention provide building blocks with internal electrical circuits (such as LED circuits) that can be mechanically and electrically connected to other blocks with integrated mechanical and electrical connectors. Each block in the present invention may include a plurality of mechanical and electrical connectors that can be joined with the connectors on other blocks. It is desired in these embodiments that the electrical connectors are designed such that they cannot be connected in a manner that results in a short circuit, either due to improper connection of the blocks or due to contact with an external conductor. This is achieved by using card edge type electrical connectors with complementary receptacles. The electrical connectors are recessed inside the mechanical connectors such that there are no exposed electrical contact surfaces. Additionally, the electrical connectors have their contacts arranged such that the proper polarities are maintained regardless of the orientation of the blocks.

Certain embodiments of the present invention also provide blocks that can be connected in three dimensions. To achieve this, each block has connectors on a plurality of faces and nearly any block can be coupled with any other block.

Accordingly, a first aspect of the present invention is to provide a powered building block of a building block toy system including a housing having a male mechanical connector extending from the housing and a female mechanical connector provided on the housing; and a circuit board, including a functional circuit, housed within the housing; where the circuit board includes a male card edge connector extending into either the male mechanical connector or the female mechanical connector; where the circuit board includes a female card edge receptacle, which extends into either the male mechanical connector or the female mechanical connector; and where the functional circuit is adapted to be activated when either the male card edge connector or female card edge receptacle of the circuit board is coupled to a powered corresponding female card edge receptacle or male card edge connector.

In a further embodiment of the first aspect, the circuit board is a planar circuit board and the block further includes: a second male mechanical connector extending from the housing and a second female mechanical connector provided on the housing; a second planar circuit board housed within the housing on a plane substantially perpendicular to a plane of the first circuit board, where the second circuit board includes a male card edge connector extending into the second male mechanical connector or the second female mechanical connector, and the second circuit board includes a female card edge receptacle, which extends into the second male mechanical connector or the second female mechanical connector. In a further detailed embodiment, the first circuit board is electrically coupled to the second circuit board and the first functional circuit is further adapted to be activated when either the male card edge connector or female card edge receptacle of the second circuit board is coupled to a powered corresponding female card edge receptacle or male card edge connector. In an alternative further detailed embodiment, the second circuit board includes a second functional circuit and the second functional circuit is adapted to be activated when either the male card edge connector or female card edge receptacle of the second circuit board is coupled to a powered corresponding female card edge receptacle or male card edge connector. In an alternative further detailed embodiment, the housing includes a plurality of vertical outer faces and a plurality of horizontal outer faces; the first male mechanical connector and the first female mechanical connector are provided on a respective pair of the vertical outer faces; and the second male mechanical connector and the second female mechanical connector are provided on a respective pair of the horizontal outer faces, and, optionally, the first male mechanical connector and the first female mechanical connector are provided on an opposed pair of the vertical outer faces; and the second male mechanical connector and the second female mechanical connector are provided on an opposed pair of the horizontal outer faces.

In an alternative further embodiment of the first aspect, the male card edge connector of the first circuit board includes a segment of the first circuit board, and the segment has two opposed first circuit board faces; each of the two opposed first circuit board faces include at least two conductive contacts; and each one of the two conductive contacts on one of the two first circuit board faces is shorted to a respective one of the two conductive contacts on the other of the two first circuit board faces.

In another alternative further embodiment of the first aspect, the first functional circuit includes a light emitting diode that becomes lit when the first functional circuit is activated. Optionally, the housing includes at least one wall that is substantially translucent or substantially transparent to allow light from the LED to be seen outside of the block.

A second aspect of the invention is to provide a powered building block toy kit including: a power source block having a power supply circuit, at least one male mechanical connector or female mechanical connector, and including at least one of a male card edge connector and a female card edge receptacle positioned within the mechanical connector and electrically coupled to the power supply circuit; and a plurality of building blocks, each building block including: a housing having a male mechanical connector and a female mechanical connector; and a circuit board, including a functional circuit, housed within the housing; the circuit board including a male card edge connector extending into the first male mechanical connector or the female mechanical connector; the circuit board including a female card edge receptacle, which extends into the other the male mechanical connector or the female mechanical connector; and the functional circuit being adapted to be activated when either the male card edge connector or female card edge receptacle of the first circuit board is coupled to a powered corresponding female card edge receptacle or male card edge connector.

A third aspect of the present invention is to provide a building block of a powered building block toy system that includes: a housing having a first mechanical male connector extending therefrom, a first female mechanical connector provided thereon, a second male connector extending therefrom on plane substantially perpendicular to the first male mechanical connector, and a second female mechanical connector provided thereon on a plane substantially perpendicular to the first female mechanical connector; and one or more functional circuits provided within the housing, where the functional circuit(s) collectively include electrical contacts extending into the first and second mechanical male connectors and the first and second mechanical female connectors. In a further detailed embodiment, the electrical contacts reside on card-edge connector components respectively extending into the first and second mechanical male connectors and the first and second mechanical female connectors. In yet a further detailed embodiment, the functional circuit(s) and the card-edge connector components are mounted to at least one circuit board, which is mounted within the housing. In further detailed embodiment, each card-edge connector includes at least four electrical contacts arranged, looking into the card-edge connector, in a rectangle; the electrical contacts in each pair of diagonally opposed corners of the rectangle are shorted to one another; one pair of diagonally opposed corners is a Vcc line; and the other pair of diagonally opposed corners is a ground line.

In an alternate detailed embodiment of the third aspect of the present invention, the functional circuit includes an LED circuit and the housing comprises a transparent or translucent material that allows light emitted from the LED circuit to be seen therethrough. In another alternate detailed embodiment of the third aspect of the present invention, the block includes at least two functional circuits and each functional circuit is mounted on a respective one of at least two circuit boards housed within the housing. In a more detailed embodiment, the planes of the at least two circuit boards are oriented within the housing perpendicular to one another.

### BRIEF DESCRIPTION OF THE DRAWING

FIG. 1 illustrates an exemplary cubical block form according to an exemplary embodiment of the present invention.

FIG. 2. shows an exemplary three-dimensional internal circuit board assembly according to an exemplary embodiment of the present invention.

FIG. 3. shows a close-up perspective view of an exemplary male card edge connector according to an exemplary embodiment of the present invention.

FIG. 4 shows an end view of an exemplary male card edge connector according to an exemplary embodiment of the present invention.

FIG. 5 shows an exemplary cylindrical block form of the preferred embodiment according to an exemplary embodiment of the present invention.

FIG. 6 shows an exemplary spherical block form of the preferred embodiment according to an exemplary embodiment of the present invention.

FIG. 7 shows an exemplary triangular block form of the preferred embodiment according to an exemplary embodiment of the present invention.

FIG. 8 shows a second exemplary triangular block form of the preferred embodiment according to an exemplary embodiment of the present invention.

FIG. 9 shows a front view of an exemplary power supply base according to an exemplary embodiment of the present invention.

FIG. 10 shows a top view of an exemplary power supply base according to an exemplary embodiment of the present invention.

FIG. 11 shows a circuit diagram of an exemplary powered building block system according to the present invention.

### DETAILED DESCRIPTION OF THE INVENTION

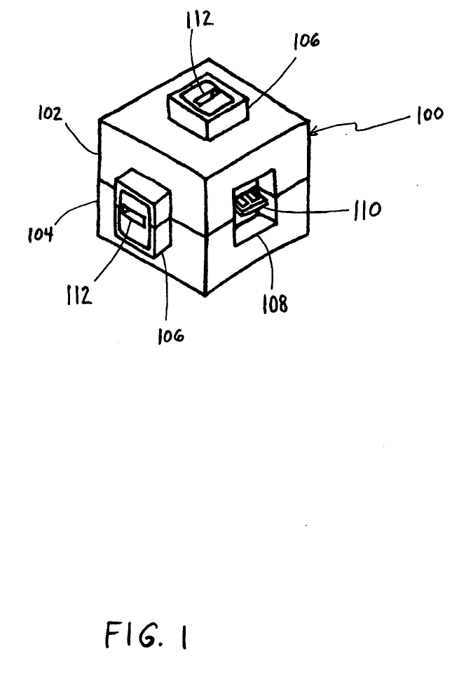

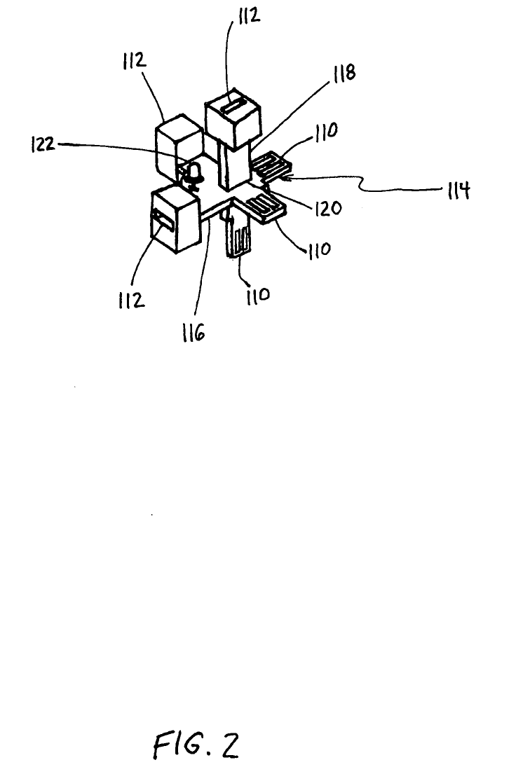

As shown in FIG. 1, an exemplary cubical building block 100 according to an exemplary embodiment of the present invention is generally cubical in shape and is constructed from two halves: an upper half 102 and a lower half 104. (The terms “upper” and “lower” are used to merely distinguish the two halves from one another and not intended to require any specific orientation—indeed, the terms “left” and “right” could have been used for the same purpose. This type of nomenclature is used throughout this application.) Each half is molded of colored, transparent or translucent plastic. Together the halves form an interior chamber, which houses the circuit boards, electrical components, and electrical conductors therein. The building block 100 is assembled by aligning the circuit board assembly 114 (shown in FIG. 2) in one half, 102 or 104, and then bonding the two halves 102, 104 together. The circuit board internally electrically connects the various external connectors and includes a light emitting diode (“LED”) that lights when electrical power is supplied to the block. When lit, the LED is visible through the transparent/translucent plastic of the block 100. As will be appreciated by those of ordinary skill in the art, the transparent/translucent materials may be other than plastic (for example, and without limitation, the block materials may include or comprise a glass or ceramic material). Furthermore, the materials of the block housing may be selected and colored so that the internal LED(s) appear to light up the entire block when activated. It is also within the scope of the invention to incorporate various reflectors or reflective properties in the block design to allow exhibition of various visual effects; and it is also within the scope of the invention that certain areas of the block housing may be opaque.

The exemplary cubical building block 100 includes three male mechanical connectors 106, two of which are visible in FIG. 1. The exemplary cubical block also includes three female mechanical connectors 108 (one of which is visible in FIG. 1), each of which oppose a complementary male mechanical connector 106. The male mechanical connectors 106 and female mechanical connectors 108 are complementary in size and shape such that a male connector 106 fits snugly inside a female connector 108, thereby mechanically joining two blocks via a friction fit in the exemplary embodiment. Electrical connections are provided by male card edge connector 110 segments of an interior circuit board, which extend out from the interior chamber into the rectangular depressions that form the female mechanical connectors 108, and female card edge receptacles 112, coupled to the interior circuit board, located within the male mechanical connectors 106. Locating the male card edge connectors 110 within the female mechanical connectors 108 prevents a short circuit from occurring due to the contacts on the male card edge connector 110 making an accidental electrical connection with an external conductor. The female card edge receptacles 112 do not present an external short circuit hazard because the electrical contacts are completely internal to the receptacles 112. Additionally, the male card edge connectors 110 are protected from mechanical damage due to their location within the female mechanical connectors 108. By having the mechanical connectors extending in three dimensions, the present invention allows for a three dimensional construction of the building blocks, while maintaining powered connections with a power source.

In the exemplary embodiment, the mechanical connectors 106, 108 are non-square rectangular in cross section such that they can only be connected in two orientations 180 degrees apart. This ensures that the male card edge connector 110 will be properly aligned to fit in the female card edge receptacle 112 of the other block. The male card edge connectors 110 and female card edge receptacles 112 have their contacts arranged such that proper polarity is assured in either of the two possible orientations in which the blocks can be connected. The mechanical connectors 106, 108, card edge connectors 110, and receptacles 112 are universal on all shapes and sizes of blocks so that all blocks can be joined together.

FIG. 2. shows an exemplary three-dimensional internal circuit board assembly 114 that resides within the chamber of the cubical block shown in FIG. 1. The internal circuit board assembly 114 is comprised of a first planar circuit board 116 and a second perpendicular circuit board 118. The second circuit board 118 extends through in a slot 120 in the first circuit board 116. The internal circuit board assembly includes three male card edge connectors 110 and three opposed female card edge receptacles 112. An LED 122 is affixed to the first circuit board 116, and is electrically connected to an electrical LED circuit built on the circuit board for providing power to the LED when either one of the edge-connectors or receptacles is connected to a powered corresponding receptacle/edge-connector of another block or the powered base. First circuit board 118 includes a resistor (not shown) electrically connected in series with the LED. The circuit boards 116, 118 may be electrically connected to each other by traces on the boards (not shown) and/or solder connections on the circuit boards (not shown) adjacent to the slot 120. Thus, when either one of the edge-connectors or receptacles of the second perpendicular circuit board is connected to a powered corresponding receptacle or edge-connector of another block or of the powered base, power will be provided to the LED circuit to light the LED. It is also within the scope of the invention that each of the first and second circuit boards include separate and unconnected LEDs and LED circuits.

The female card edge receptacles 112 are standard PCI slot type connectors designed to receive a male card edge connector with four contacts. When the internal circuit board assembly 114 is installed in a block, such as a cubical block 100, the female card edge receptacles 112 are physically restrained by the interior surfaces of the protruding mechanical connectors 106 such that any forces applied to the female card edge receptacles 112 are felt by the blocks themselves and not the solder or other connections on the circuit boards 116 or 118. The card edge connectors of the present invention have also been found to be rather difficult to damage.

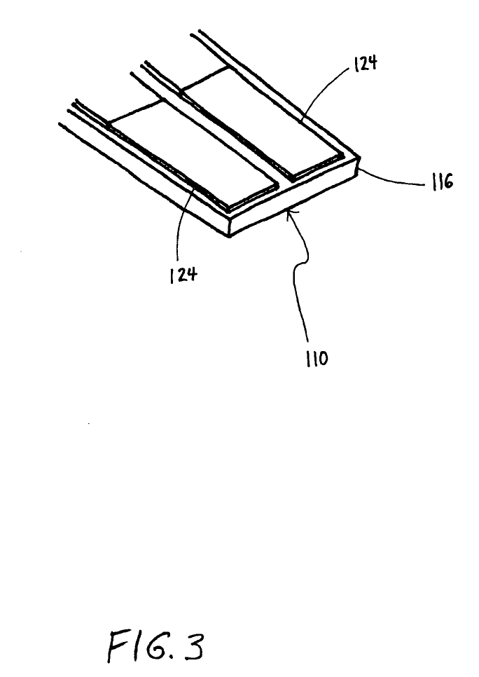

FIG. 3. shows a close-up perspective view of an exemplary male card edge connector 110. Two contacts 124 are present on each face of the circuit board 116 for a total of four contacts 124 per male card edge connector 110. The contacts 124 on each face of the circuit board are electrically isolated from each other.

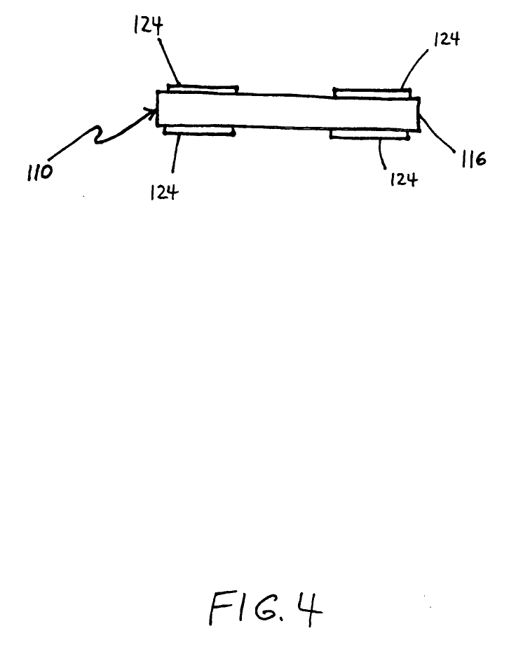

FIG. 4 shows an end view of an exemplary male card edge connector 110. The four contacts 124 are visible on the surfaces of the circuit board 116. The contacts 124 are arranged such that like polarities are diagonally opposite each other. This allows the connector to be properly connected to a female card edge receptacle 112 in either of two orientations 180 degrees apart. As described above, the mechanical connectors 106, 108 are shaped such that the blocks can only be connected in the two orientations which result in proper electrical connections between the male card edge connector 110 and the female card edge receptacle 112. In the exemplary embodiment each diagonally opposed pair of contacts is shorted together, where a first diagonally opposed pair is the voltage contact and the other diagonally opposed pair is the ground contact for the circuit.

Because the exemplary embodiment of the invention includes four contacts 124 in each electrical connector 110, 112 when only two conductors are required, reliability of the connections is enhanced. The blocks will continue to properly conduct an electric current if any one contact is damaged, corroded, or otherwise out of service. Depending on which additional contacts are out of service, it is possible that numerous other contacts could fail and the invention will still function properly. This is an advantage to the present invention because users, children in particular, may become frustrated if a single, unidentified failed contact prevents an entire constructed object from functioning properly.

It will be appreciated that other types of commercially-available board-to-board card-edge connectors would also be suitable for use with the present invention. Such alternative card-edge connectors would include, without limitation, pin-type card-edge connectors.

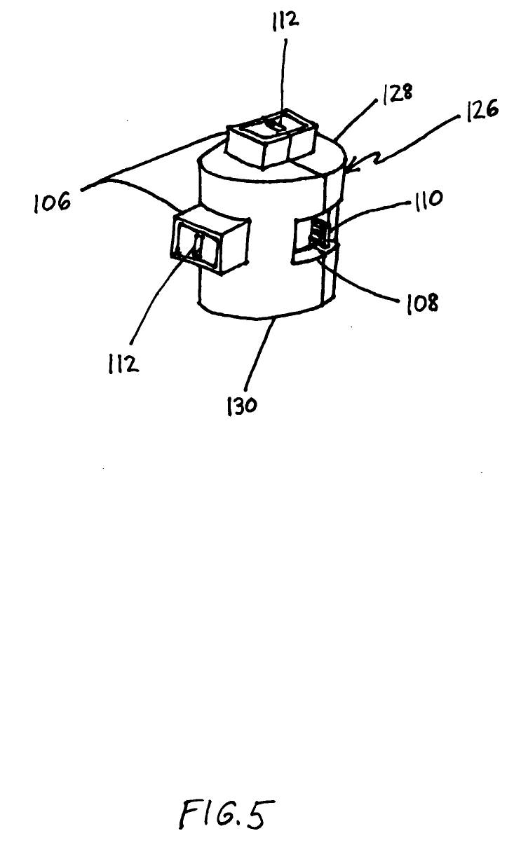

FIG. 5 shows a cylindrical building block 126 exemplary embodiment of the present invention. The cylindrical block 126 utilizes the same internal circuit board assembly 114 (shown in FIG. 2) that is used in the cubical block 100 illustrated in FIG. 1. The cylindrical block 126 is comprised of two pieces 128, 130 that are molded of colored, transparent or translucent plastic. Together the pieces form an interior chamber, which houses the circuit boards, electrical components, and electrical conductors therein. The cylindrical block 126 includes three male mechanical connectors 106 (only two are visible in FIG. 5) and three female mechanical connectors 108 (only one is visible in FIG. 5). Male card edge connectors 110 extend out from the interior chamber formed by the two halves into the rectangular depressions that provide the female mechanical connectors 108. Female card edge receptacles 112, coupled to the interior circuit board, are housed within the male mechanical connectors 106. The mechanical connectors 106, 108 couple to corresponding connectors on other blocks via a friction fit.

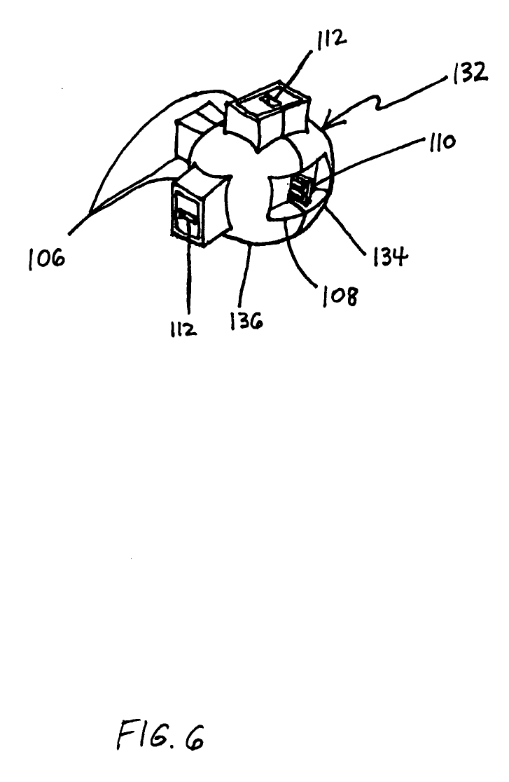

FIG. 6 shows a spherical building block 132 exemplary embodiment of the present invention. The spherical block 132 utilizes the same internal circuit board assembly 114 (shown in FIG. 2) that is used in the cubical block 100 illustrated in FIG. 1. The spherical block 132 is comprised of two pieces 134, 136 that are molded of colored, transparent or translucent plastic. Together the pieces form an interior chamber, which houses the circuit boards, electrical components, and electrical conductors therein. The spherical block 132 includes three male mechanical connectors 106 and three female mechanical connectors 108 (only one is visible in FIG. 6). Male card edge connectors 110 extend out from the interior chamber formed by the two halves into the rectangular depressions that provide the female mechanical connectors 108. Female card edge receptacles 112, coupled to the interior circuit board, are housed within the male mechanical connectors 106. The mechanical connectors 106, 108 couple to corresponding connectors on other blocks via a friction fit.

It may be desired that the spacing and orientation of the cylindrical building block's 126 and spherical block's 132 mechanical connectors 106, 108 is identical to that of the cubical block 100 in the exemplary embodiment. This is advantageous to the user because it enables him or her to construct an object using a plurality of blocks that are uniformly sized even though they have different shapes.

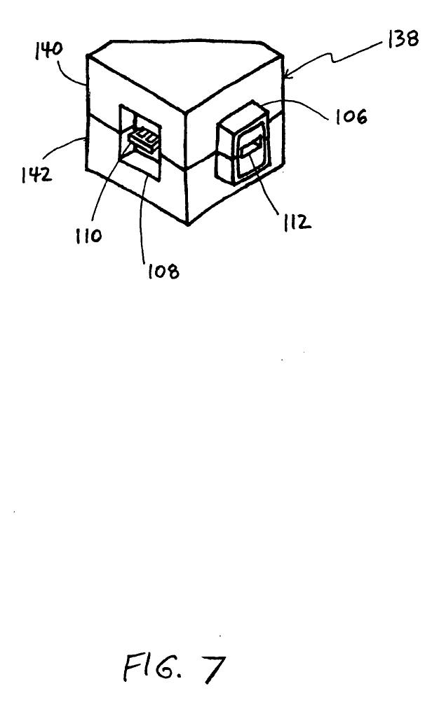

FIG. 7 shows a triangular building block 138 exemplary embodiment of the present invention. The block 138 is generally triangular in shape and is constructed of colored, transparent or translucent molded plastic in two halves, an upper half 140 and a lower half 142. Together the halves form an interior chamber, which houses the circuit boards, electrical components, and electrical conductors therein. The block 138 includes three mechanical connectors: two male mechanical connectors 106 (only one is visible in FIG. 2) and one female mechanical connector 108. The mechanical connectors 106, 108 couple to corresponding connectors on other blocks via a friction fit. A male card edge connector 110 extends out from the interior chamber formed by the two halves into the rectangular depression that provides the female mechanical connector 108. Female card edge receptacles 112, coupled to the interior circuit board, are housed within the male mechanical connectors 106. An internal circuit board, similar to the one shown in FIG. 2, connects the various external connectors and includes an LED that lights when electrical power is supplied to the block. When lit, the LED is visible through the transparent/translucent plastic of the block 138.

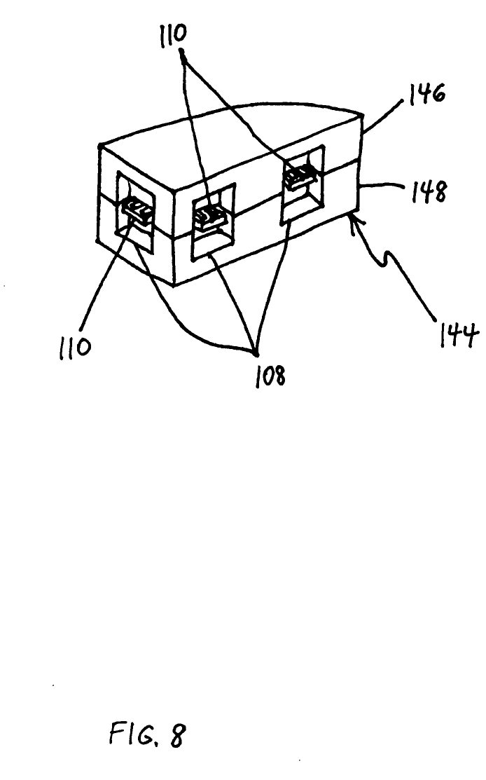

FIG. 8 illustrates an alternative triangular building block 144 form of the present invention. The block 144 is generally triangular in shape, with a curved hypotenuse, and is constructed of colored, transparent or translucent molded plastic in two halves, an upper half 146 and a lower half 148. Together the halves form an interior chamber, which houses the circuit boards, electrical components, and electrical conductors therein. The block 144 includes three female mechanical connectors 108. The mechanical connectors 108 couple to corresponding connectors on other blocks via a friction fit. Male card edge connectors 110 extend out from the interior chamber formed by the two halves into the rectangular depressions that provide the female mechanical connectors 108. An internal circuit board, similar to the one shown in FIG. 2, connects the various external connectors and includes an LED that lights when electrical power is supplied to the block. When lit, the LED is visible through the transparent/translucent plastic of the block 144.

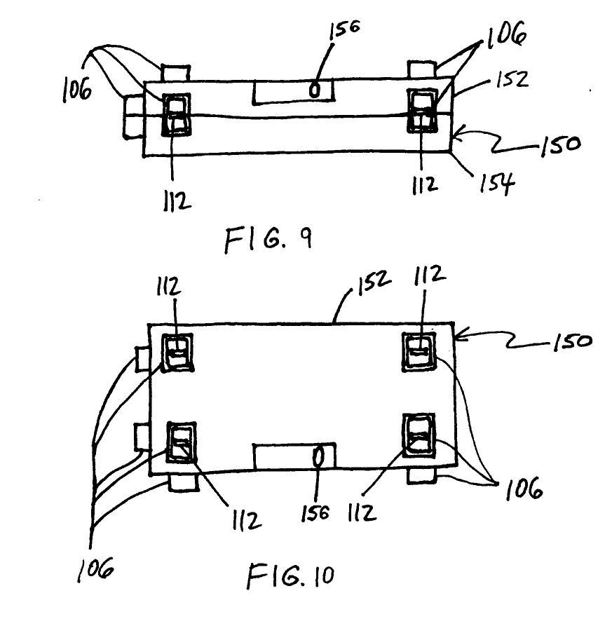

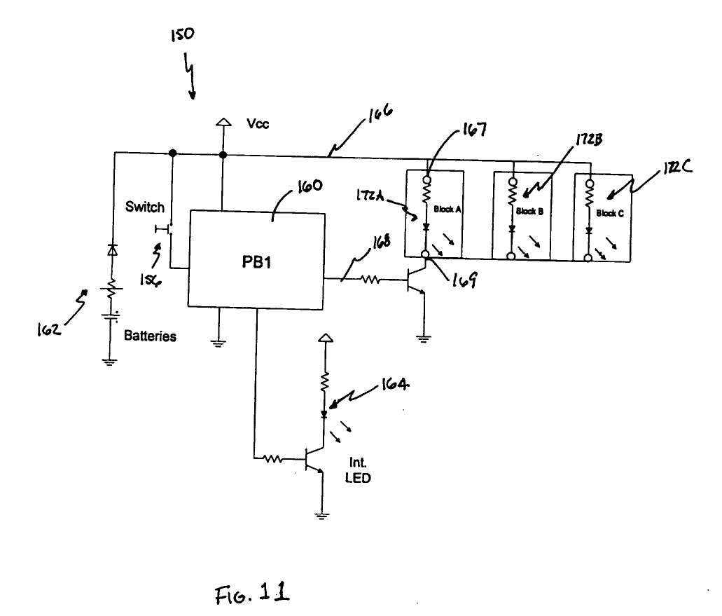

FIGS. 9 and 10 show front and top views of a power supply block 150 in the exemplary embodiment. The power supply block 150 is constructed from an upper half 152 and a lower half 154, each of which is molded, at least in part, of colored, transparent or translucent plastic (or of other suitable materials). Together the halves form an interior chamber, which houses the batteries, circuit boards, electrical components, and electrical conductors therein. The power block 150 in this embodiment includes eight male mechanical connectors 106 and four female mechanical connectors 108 (not visible in FIGS. 9 and 10). Male card edge connectors 110 extend out from the interior chamber formed by the two halves into the rectangular depressions that provide the female mechanical connectors 108. Female card edge receptacles 112, coupled to the interior circuit board, are housed within the male mechanical connectors 106. The mechanical connectors 106, 108 couple to corresponding connectors on other building blocks (as shown, for example in FIGS. 1-8) via a friction fit. A button/switch 156 controls the power supply. Inside the power block 150 are a battery box containing three dry cell batteries and a control circuit. Additionally, an LED that lights when power is supplied is provided.

To construct an object using the exemplary embodiment of present invention, a user simply aligns the a male mechanical connector 110 of one block with the female mechanical connector 111 of another block and presses the blocks together. The blocks remain coupled due to a friction fit between the mechanical connectors. Due to the design described above, the proper electrical connections are made as the mechanical connection is made. The user repeats this process with a plurality of blocks to construct the desired object. If one of the blocks in the chain of blocks is the power supply block 150, then the power supply block will power the circuits of all of the chain of building blocks coupled to it. Each of the mechanical connections can be disconnected by pulling the blocks apart. Thus the blocks are completely reusable.

As shown in FIG. 11, an exemplary circuit diagram is illustrated. In the power supply block 150 a conventional power supply control circuit chip 160 is provided. A battery power source 162 is also provided and a switch 156 is coupled between the battery power source 162 and the control circuit chip 160. An internal LED 164 is activated by the control circuit chip 160 whenever the switch is closed. The control circuit chip 160 also includes at least one VCC (power) output line 166 electrically coupled to electrical connector pin 167 and at least one ground output line 168 providing ground for electrical connector pin 169. In this exemplary diagram, three of the building blocks (such as described with respect to FIGS. 1-8) labeled as Block A, Block B and Block C are mechanically and electrically coupled to one another and to the power supply block 150 as described herein. In this example, Block A is mechanically and electrically coupled to the power supply block 150, while Block B is coupled to Block A and Block C is coupled to Block C. Each of the building blocks include an internal LED circuit 172A, 172B or 172C that is electrically connected in parallel to the power supply control circuit chip 160 and to each other.

In the exemplary embodiment, the system power is 4.5V powered by 3 AAA batteries, where the current varies with the number of blocks coupled to it. In an embodiment, the power supply control circuit 160 is designed to sense an overload condition in which too many of the building blocks are connected to it. When this overload condition is sensed, the power supply control circuit 160 is programmed to internally shut down power to the building blocks. It is also within the scope of the invention that the power control circuit include a “try me” function; such that when it is packaged for sale, activation of the switch 156 will only temporarily power the internal LED 164 and any building block mounted thereto.

While the preferred embodiment incorporates only a dual conductor electrical system, one positive conductor (e.g., VCC) and one negative conductor (e.g, ground), it is within the scope of the invention to utilize additional conductors to carry other electrical signals or currents in either directions.

It is also within the scope of the invention that the functional circuit within each block performs a function or functions in addition to or in lieu of lighting a LED. Blocks may be adapted to perform functions as output devices such as lights, sound generators, or heating or cooling elements. Blocks may be adapted to perform functions as input devices such as microphones, photocells, voltage or current detectors, pressure detectors, or motion detectors. Additionally, blocks may be adapted to perform motive functions such as motors, winches, fans, reciprocating elements, or extending and/or retracting elements. Blocks may also be adapted to perform power supply functions such as energy generation, conversion, or storage. Blocks may be adapted to perform control functions such as supplying and securing power in response to outside stimuli, selectively supplying power to certain elements of an electrical circuit, automatically securing a power supply after a certain amount of time has elapsed, or securing a power supply if indications of a short circuit or other malfunction are present.

Following from the above description and invention summaries, it should be apparent to those of ordinary skill in the art that, while the objects herein described constitute exemplary embodiments of the present invention, it is to be understood that the invention is not limited to these precise objects and that changes may be made therein without departing from the scope of the invention as defined by the claims. Additionally, it is to be understood that the invention is defined by the claims and it is not intended that any limitations or elements describing the exemplary embodiments set forth herein are to be incorporated into the meaning of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A building block of a powered building block toy system comprising:
a housing having a first mechanical male connector extending therefrom and a first female mechanical connector provided thereon; and
a first circuit board, including a first functional circuit provided thereron, housed within the housing;
the first circuit board including a male card edge connector extending into one of the first mechanical male connector and the first mechanical female connector;
the first circuit board including a female card edge receptacle coupled thereto, which extends into the other one of the first mechanical male connector and the first mechanical female connector; and
the first functional circuit being adapted to be activated when either one of the male card edge connector and female card edge receptacle of the first circuit board is coupled to a powered corresponding female card edge receptacle or male card edge connector.

2. The building block of claim 1, wherein the first circuit board is a planar circuit board and the block further comprises:
a second mechanical male connector extending from the housing and a second female mechanical connector provided on the housing;
a second planar circuit board housed within the housing on a plane substantially perpendicular to a plane of the first circuit board, wherein the second circuit board includes a male card edge connector extending into one of the second mechanical male connector and the second mechanical female connector, and the second circuit board including a female card edge receptacle coupled thereto, which extends into the other one of the second mechanical male connector and the second mechanical female connector.

3. The building block of claim 2, wherein the first circuit board is electrically coupled to the second circuit board and the first functional circuit is further adapted to be activated when either one of the male card edge connector and female card edge receptacle of the second circuit board is coupled to a powered corresponding female card edge receptacle or male card edge connector.

4. The building block of claim 2, wherein the second circuit board includes a second functional circuit and the second functional circuit is adapted to be activated when either of the male card edge connector and female card edge receptacle of the second circuit board is coupled to a powered corresponding female card edge receptacle or male card edge connector.

5. The building block of claim 2, wherein:
the housing includes a plurality of vertical outer faces and a plurality of horizontal outer faces;
the first male mechanical connector and the first female mechanical connector are provided on a respective pair of the vertical outer faces; and
the second male mechanical connector and the second female mechanical connector are provided on a respective pair of the horizontal outer faces.

6. The building block of claim 5, wherein:
the first male mechanical connector and the first female mechanical connector are provided on an opposed pair of the vertical outer faces; and
the second male mechanical connector and the second female mechanical connector are provided on an opposed pair of the horizontal outer faces.

7. The building block of claim 1, wherein:
the male card edge connector of the first circuit board includes a segment of the first circuit board, and the segment has two opposed first circuit board faces;
each of the two opposed first circuit board faces include at least two conductive contacts; and
each one of the two conductive contacts on one of the two first circuit board faces is shorted to a respective one of the two conductive contacts on the other of the two first circuit board faces.

8. The building block of claim 1, wherein the first functional circuit includes a light emitting diode that becomes lit when the first functional circuit is activated.

9. The building block of claim 8, wherein the housing includes at least one wall that is at least one of substantially translucent and substantially transparent.

10. A powered building block toy kit comprising:
a power source block having a power supply circuit, at least one mechanical connector taken from a group consisting of a male mechanical connector and a female mechanical connector, and including at least one of a male card edge connector and a female card edge receptacle positioned within the mechanical connector and electrically coupled to the power supply circuit; and
a plurality of building blocks, each building block including,
a housing having a first mechanical male connector extending therefrom and a first female mechanical connector provided thereon; and
a first circuit board including a first functional circuit provided thereron, housed within the housing;
the first circuit board including a male card edge connector extending into one of the first mechanical male connector and the first mechanical female connector;
the first circuit board including a female card edge receptacle coupled thereto, which extends into the other one of the first mechanical male connector and the first mechanical female connector; and
the first functional circuit being adapted to be activated when either one of the male card edge connector and female card edge receptacle of the first circuit board is coupled to a powered corresponding female card edge receptacle or male card edge connector.

11. The powered building block toy kit of claim 10, wherein the first functional circuit electrically connects to the power supply circuit in a parallel circuit connection.

12. The powered building block toy kit of claim 11, wherein the power supply circuit includes an overload sensor and is adapted to cut power to the first functional circuit upon sensing an overload condition.

13. A building block of a powered building block toy system comprising:
a housing having a first mechanical male connector extending therefrom, a first female mechanical connector provided thereon, a second male connector extending therefrom on plane substantially perpendicular to the first male mechanical connector, and a second female mechanical connector provided thereon on a plane substantially perpendicular to the first female mechanical connector; and
one or more functional circuits provided within the housing, the one or more functional circuits collectively including electrical contacts extending into the first and second mechanical male connectors and the first and second mechanical female connectors.

14. The building block of claim 13, wherein the electrical contacts reside on card-edge connector components respectively extending into the first and second mechanical male connectors and the first and second mechanical female connectors.

15. The building block of claim 14, wherein the one or more functional circuits and the card-edge connector components are mounted to at least one circuit board, which is mounted within the housing.

16. The building block of claim 13, wherein the functional circuit includes an LED circuit and the housing comprises a transparent or translucent material that allows light emitted from the LED circuit to be seen therethrough.

17. The building block of claim 13, wherein the block includes at least two functional circuits and each functional circuit is mounted on a respective one of at least two circuit boards housed within the housing.

18. The building block of claim 17, wherein the planes of the at least two circuit boards are oriented within the housing perpendicular to one another.

19. The building block of claim 14, wherein:
each card-edge connector includes at least four electrical contacts arranged, looking into the card-edge connector, in a rectangle;
the electrical contacts in each pair of diagonally opposed corners of the rectangle are shorted to one another;
one pair of diagonally opposed corners is a positive polarity; and
the other pair of diagonally opposed corners is one of a negative polarity and ground.
